(19) United States
(12) Patent Application Publication
(10) Pub. No.: US 2010/0164159 A1
(43) Pub. Date: Jul. 1, 2010

(54) CLAMPING DEVICE

(75) Inventor: Adolf Würthele, Guntershausen (CH)

Correspondence Address: Fleit Gibbons Gutman Bongini & Bianco PL, 21355 EAST DIXIE HIGHWAY, SUITE 115, MIAMI, FL, 33180, US

(73) Assignee: GRESSEL AG, Aadorf (CH)

(21) Appl. No.: 12/600,549

(22) PCT Filed: Mar. 28, 2008
(86) PCT No.: PCT/EP08/53703

§ 371 Date: Feb. 16, 2010

(30) Foreign Application Priority Data
Jun. 13, 2007 (DE) 10 2007 027 808.1

(51) Int. Cl. B25B 1/10; B25B 1/24

(52) U.S. Cl. 269/242; 269/280; 269/256

(57) ABSTRACT

The invention relates to a clamping device which contains a structure (1), two carriers (2, 3) which are disposed in the structure (1) and have at least one clamping jaw (5, 6) each, and an adjusting spindle (4) for adjusting at least one carrier (2). In order to make possible a compact, relatively inexpensive construction which is protected against contamination, the carriers (2, 3) are constructed as half shells surrounding the adjusting spindle (4).

### FIELD OF THE INVENTION

The invention relates to a clamping device.

### BACKGROUND OF THE INVENTION

Such a clamping device is known from U.S. Pat. No. 1,811,299 A. This contains two carriers shiftably guided in a structure that each carry a clamping jaw and can be shifted in opposite directions by an adjusting spindle constructed as a threaded spindle. The clamping jaws arranged on the carriers can be moved together at the same time with the aid of the adjusting spindle, which makes possible a central clamping of workpieces. In order to prevent contamination of the threaded spindle and the entrance of chips into the receiving and guidance conduit inside the structure in this known clamping device, additional covering sheets are screwed on the bottom of the clamping jaws, overlap each other between the clamping jaws and are pushed against each other during the adjusting of the clamping jaws with them. As a result, the entrance of chips into the receiving and guidance conduit as well as contamination of the adjusting spindle can be prevented. However, not only is the number of individual parts increased by such additional covering sheets but the complexity of manufacturing and assembly is also increased, which is generally associated with correspondingly higher expenses.

EP 1 688 219 A1 describes a clamping device with a first clamping jaw attached to a structure and with a second clamping jaw attached to a carriage. The carriage is supported in such a manner that it can be adjusted along an upper side of the structure by a screw spindle, which screw spindle is arranged in a spindle recess of the structure directed to the upper side. This prevents the entrance of chips in that the spindle recess of the structure is covered between the two clamping jaws by a covering element.

### SUMMARY OF THE INVENTION

The invention has the objective of creating a clamping device that makes possible an extremely compact, inexpensive construction protected against contamination without additional coverings.

This problem is solved by a clamping device as set forth in the claims. Purposeful further developments and advantageous embodiments of the invention are subject matter of the dependent claims.

In the clamping device in accordance with the invention, the carriers constructed for receiving the clamping jaws are constructed as half shells surrounding the adjusting spindle. The adjusting spindle is covered by these half shells and a closed, level support surface for the clamping jaws is formed. Thus, no pockets, open guides or recesses are present between the clamping jaws that could serve as spaces for trapping chips or cooling lubricant. As a result, not only is the adjusting spindle protected from contamination or damage but also the cleaning of the clamping device is significantly simplified since the chips present between the clamping jaws can simply be wiped off. Thus, the construction in accordance with the invention ensures reliable and permanent functioning even under a heavy load of chips or cooling lubricant. Furthermore, the clamping device in accordance with the invention is constructed in an extremely compact manner and can be manufactured in a simple and inexpensive manner with a small number of parts.

The two carriers are preferably constructed as longitudinal rails arranged in parallel adjacent to one another that comprise a recess shaped like a half-shell on the inner sides facing each other and resting on each other for forming a closed receiver for the adjusting spindle. The adjusting spindle is thus completely surrounded and optimally protected from contamination and damage. The carriers are advantageously constructed in the same manner. As a result thereof, the production cost can be lowered and the manufacturing expense reduced.

In an especially advantageous embodiment, the clamping device is constructed as a central clamping device in which the two carriers are shiftably guided in the structure and can be adjusted in opposite directions by the adjusting spindle. This makes possible a rapid and central clamping of workpieces. However, one of the two carriers can also be stationary and have only the other carrier shift relative to it.

For the additional guidance of the two carriers the clamping jaws comprise webs projecting downward on their outer sides in an advantageous manner which webs extend over the two carriers at their top. The webs are constructed in such a manner that one of the webs of the clamping jaw fastened on the one carrier also extends over the carrier belonging to the other clamping jaw. As a result, the two carriers can be held together even in the case of transverse forces. Furthermore, in another advantageous embodiment the clamping jaws have a transverse web on their bottom for engaging into an associated transverse groove on the top of the carriers. This makes possible a reliable and stable connection between the clamping jaws and the particular carrier.

The clamping jaws can have any form adapted to the particular clamping task. The clamping jaws preferably contain a basic body to which replaceable, lateral and upper clamping plates are fastened. In this manner the workpieces can be clamped between the lateral as well as between the upper clamping plates.

In an inexpensive exemplary embodiment with simple manufacturing technology the adjustment of the two carriers takes place via threaded pins that cooperate with a threaded spindle as an adjusting spindle provided with right and left threadings. The threaded pins contain a threaded bore for the right and left threadings and a cam pin for engaging into a lateral receiving bore of the particular carrier. The two carriers can be shifted counter to one another via the threaded pins in the clamping jaws and thus be moved together or apart at the same time by rotating the adjusting spindle provided on their ends e.g., with an inner or outer hexagon. However, the adjusting of the two carriers can also take place via threaded sections that are constructed to engage with the threaded spindle and can be worked directly into the carriers. Even other adjusting mechanisms for the relative shifting of the two carriers constructed as half shells can be used.

### BRIEF DESCRIPTION OF THE DRAWINGS

Other particularities and advantages of the invention result from the following description of a preferred exemplary embodiment making use of the drawings.

FIG. 1 shows a clamping device in accordance with the invention with clamping jaws moved apart;

FIG. 2 shows the clamping device of FIG. 1 with clamping jaws moved together;

FIG. 3 shows the clamping device of FIG. 1 in a lateral view, and

FIG. 4 shows a schematic exploded view of the clamping device of FIG. 1.

### DETAILED DESCRIPTION OF THE INVENTION

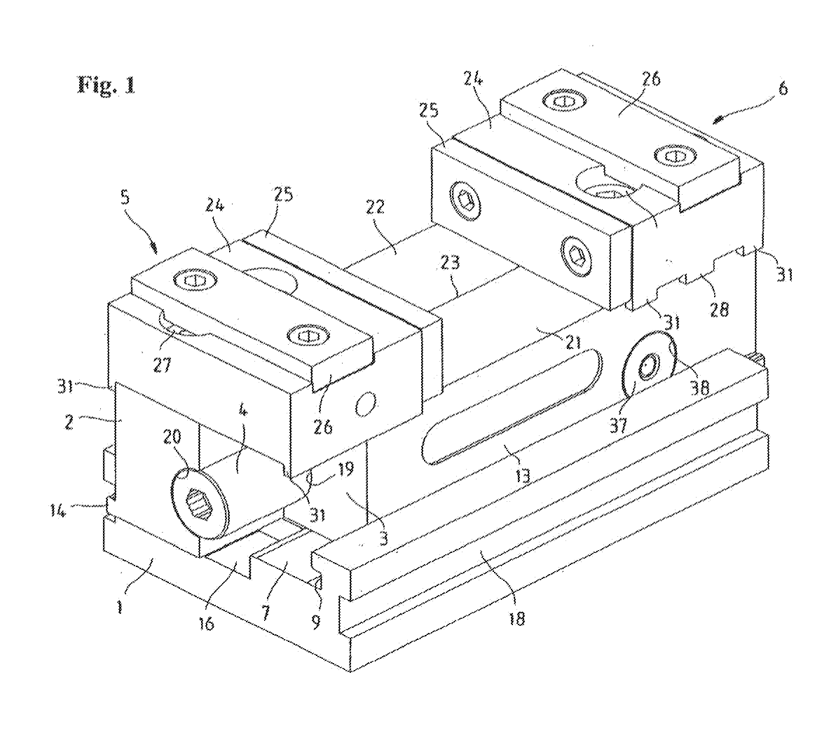

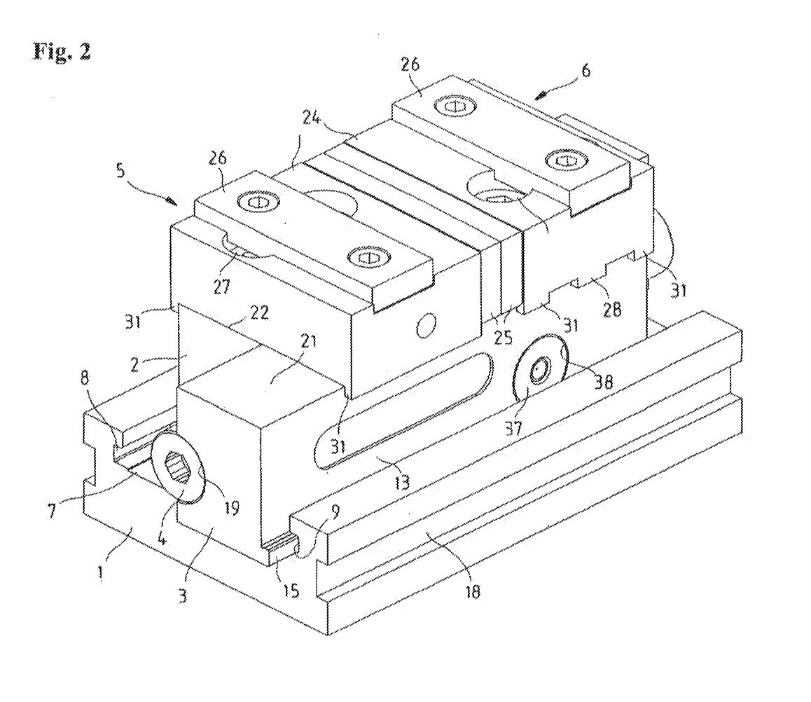

The clamping device shown in FIGS. 1-4 in different views contains a structure 1 in which two carriers 2, 3 constructed as longitudinal rails arranged parallel to one another run in such a manner that they can shift relative to one another in their longitudinal direction and can be adjusted in opposite directions by an adjusting spindle 4. The two carriers 2, 3 constructed as longitudinal rails each carry a respective clamping jaw 5, 6 that can be shifted in opposite directions by rotating adjusting spindle 4, and by the adjustment of carriers 2, 3 caused thereby, between a position in which they are moved apart shown in FIG. 1 and a position in which they are moved together shown in FIG. 2. As a result thereof, workpieces can be centrally clamped between the two clamping jaws 5,6.

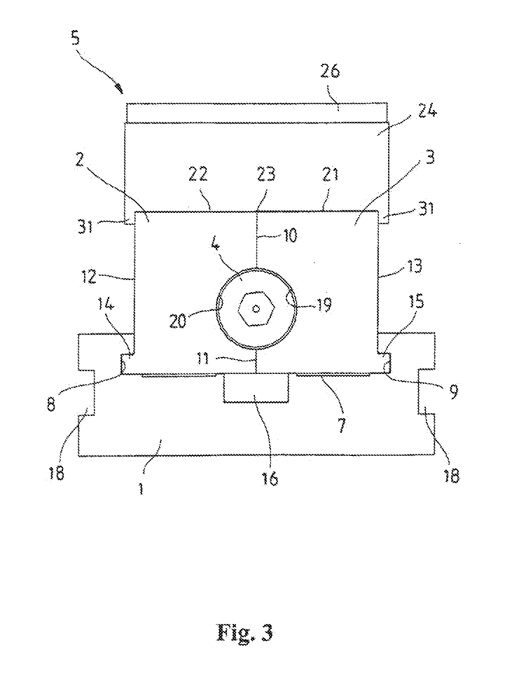

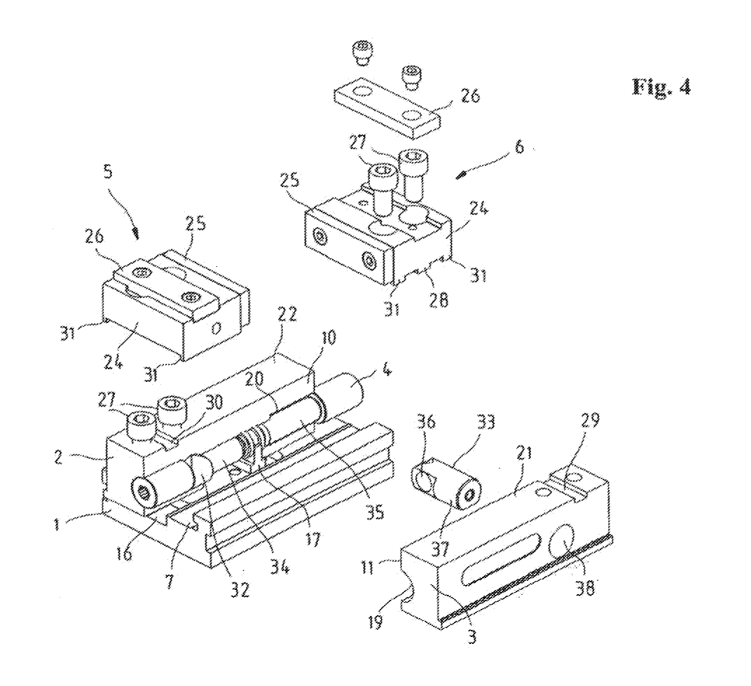

As is apparent in particular from FIG. 3, structure 1 comprises an upwardly open guide conduit 7 with a T-shaped cross section and with lateral guide grooves 8, 9. The two rail-shaped carriers 2, 3 are shiftably guided inside guide conduit 7. To this end, the two carriers 2 and 3 contacting one another at their respective inner side surfaces 10 and 11 comprise outwardly projecting guide webs 14 and 15 on their outer side surfaces 12 and 13 for engagement in the guide grooves 8 and 9 of structure 1. A receiving groove 16 running in the longitudinal direction of structure 1 is provided in the bottom of guide conduit 7 for a support block 17 shown in FIG. 4 and explained in detail in the following. In the exemplary embodiment shown, structure 1 is constructed in one piece and comprises lateral clamping grooves 18 for fastening on a supporting table or the like. However, it can also be manufactured in a multipartite manner with a lower part and screwed-on guide rails or the like. Structure 1, which is constructed in the exemplary embodiment shown as a structural component that can be clamped on, can also be constructed as a supporting table, palette carrier or the like.

The two carriers 2, 3 each have a respective recess 19, 20 shaped like a half shell on the inner sides 12, 13 facing one another that limit a through receiving for adjusting spindle 4 and surround adjusting spindle 4 over its entire circumference and almost its entire length. Carriers 2, 3 are constructed as half shells for surrounding adjusting spindle 4. An almost totally closed, level support surface for clamping jaws 5, 6 that is interrupted only by contact slot 23 is formed by the particular upper, straight surfaces 21, 22 of both carriers 2, 3. No recesses or hollow spaces for the entrance of chips are present that would have to be protected by additional covering sheets or the like.

It is apparent from FIG. 4 that a clamping jaw 5, 6 is fastened on each of the ends of the two carriers 2, 3 facing away from one another. The left clamping jaw 5 is screwed fast on the left end of the rear carrier 2 in FIG. 4 whereas the right clamping jaw 6 is fastened on the right end of the front carrier 2 in FIG. 3.

The two clamping jaws 5, 6 each have a base part 24 that can be fastened on the respective carriers 2, 3 on which base part replaceable lateral and upper clamping plates 25, 26 are fastened. The workpieces can be clamped between the lateral as well as between the upper clamping plates 25, 26. The base parts 24 are fastened by screws 27 on the particular carrier 2, 3 and comprise a transverse web 28 on their bottom for engagement into matching transverse grooves 29, 30 on the top of the two carriers 2, 3. This achieves a stable connection between carriers 2, 3 and base parts 24 of clamping jaws 5, 6. Clamping jaws 5, 6 have downwardly projecting webs 31 on the outside of their base parts 24 which webs extend over the two carriers 2, 3. Webs 31 are constructed in such a manner that one of the webs of the base part of the one clamping jaw, which base part is fastened on the one carrier, also extends over the carrier belonging to the other clamping jaw. As a result, the two carriers 2, 3 constructed as half shells are held together even in the case of transverse forces. In addition, it is possible to counteract a deviation of the clamping surfaces of clamping jaws 5, 6, which clamping surfaces are at a right angle to the longitudinal guiding axis, even in the case of a workpiece that has been clamped in on one side.

FIG. 4 shows the adjusting mechanism for shifting the two clamping jaws 5, 6. The adjustment of the two carriers 2, 3 for moving the two clamping jaws 5, 6 together and apart takes place in the exemplary embodiment shown by the adjusting spindle 4 provided with a right and a left threading 32, 33 and by the associated threaded pins 34, 35, which comprise a threaded bore 36 and a receiving pin 37 for receiving in a lateral bore 38 of carriers 2, 3. In the middle, adjusting spindle 4 can rotate in support block 17 and is securely guided in the axial direction. Support block 17 is arranged in receiving groove 16 of structure 1 and is fixed in the latter by screws or the like from below. The two carriers 2, 3 can be shifted opposite one another via threaded pins 34, 35 by rotating adjusting spindle 4, provided on its ends, e.g., with an inner or outer hexagon, and clamping jaws 5, 6 are thus simultaneously moved together or apart. Support block 17 can be shifted inside receiving groove 16 of structure 1 in its longitudinal direction and the center of the clamping stroke relative to structure 1 can be adjusted therewith.

The invention is not limited to the previously described exemplary embodiment shown in the drawings. Thus, the adjustment of the two carriers 2, 3 can take place instead of via threaded bolts also via threaded sections that are constructed for engagement with the threaded spindle and are worked directly into the carriers.

1. A clamping device that contains a structure (1), two carriers (2, 3) arranged in the structure (1) that each have at least one clamping jaw (5, 6) and an adjusting spindle (4) for adjusting at least one carrier (2), wherein the carriers (2, 3) are constructed as half shells surrounding the adjusting spindle (4).

2. The clamping device according to claim 1, wherein the two carriers (2, 3) are constructed as longitudinal rails arranged in parallel adjacent to one another that comprise a recess (19, 20) shaped like a half-shell on the inner sides (12, 13) facing each other for forming a closed receiver for the adjusting spindle (4).

3. The clamping device according to claim 1, wherein the two carriers (2, 3) form a closed, level support surface for the clamping jaws (5, 6) with their upper surfaces (21, 22).

4. The clamping device according to claim 1, wherein the carriers (2, 3) are constructed in the same manner.

5. The clamping device according to claim 2, wherein the carriers (2, 3) are shiftably guided in the structure (1) and can be adjusted in opposite directions by the adjusting spindle (4).

6. The clamping device according to claim 2, wherein the carriers (2, 3) comprise outwardly projecting guide webs (14, 15) on their outer sides (12, 13) for engaging into lateral guide grooves (8, 9) of a guide conduit (7) in the structure (1).

7. The clamping device according to claim 6, wherein a clamping jaw (5, 6) is fastened on the ends of the two carriers (2, 3) which ends face away from one another.

8. The clamping device according to claim 7, wherein the clamping jaws (5, 6) comprise downwardly projecting webs (31) on their outer sides which webs extend over the two carriers (2, 3) on their top.

9. The clamping device according to claim 8, wherein the clamping jaws (5, 6) have a transverse web (28) on their bottom for engaging into an associated transverse groove (29, 30) on the top of the carriers (2, 3).

10. The clamping device according to claim 1, wherein the clamping jaws (5, 6) contain a base part (24) to which replaceable lateral clamping plates (25) and/or upper clamping plates (26) are fastened.

11. The clamping device according to claim 2, wherein the adjusting spindle (4) is constructed as a threaded spindle with a right and a left threading (32, 33), and wherein the two carriers (2, 3) are adjusted via threaded pins (34, 35) that contain a threaded bore (36) for the right and left threading (32, 33), and a receiving pin (37) for engaging in a lateral receiving bore (38) of the particular carrier (2, 3).

12. The clamping device according to claim 1, wherein the adjusting spindle (4) is rotatably supported in a support block (17) and is securely arranged in the axial direction.

13. The clamping device according to claim 1, wherein the structure (1) is constructed as a supporting table or palette carrier.
